(19) United States
(12) Patent Application Publication
(10) Pub. No.: US 2008/0132110 A1
(43) Pub. Date: Jun. 5, 2008

(54) Card connector capable of detecting inserted card

(75) Inventors: Yaw-Huey Lai, Taipei County (TW); Xiao-Hui Wang, Guangdong Province (CN)

Correspondence Address: BACON & THOMAS, PLLC, 625 SLATERS LANE, FOURTH FLOOR, ALEXANDRIA, VA, 22314, US

(73) Assignee: TAI-SOL ELECTRONICS CO., LTD., TAIPEI CITY (TW)

(21) Appl. No.: 11/730,815

(22) Filed: Apr. 4, 2007

(30) Foreign Application Priority Data
Nov. 30, 2006 (TW) 95221171

(51) Int. Cl. H01R 3/00

(52) U.S. Cl. 439/489

(57) ABSTRACT

A card connector composed of a base frame, a plurality of conductive terminals, a first conductive tongue, a second conductive tongue, and a slide member. The base frame includes a rear sidewall. The conductive terminals are inserted close to a first side of the rear sidewall. The first and second conductive tongues are inserted close to a second side of the terminals. The first tongue includes a main body, a contact portion, a bended portion bending upward from one end of the main body, and a press portion extending toward one side of the second conductive tongue from a distal end of the bended portion. The second tongue includes a main body. The press portion of the first tongue is located above the main body of the second tongue. When the press portion is moved downward to contact the main body of the second tongue, the electrical conduction is enabled.

### BACKGROUND OF THE INVENTION

1. Field of the Invention

The present invention relates generally to electronic card connectors, and more particularly, to a card connector capable of detecting an inserted card.

2. Description of the Related Art

The currently available card connector includes two spaced tongues mounted at one lateral side thereof. During the insertion of an electronic card into the card connector, the card first works on one of the tongues to squeeze and enable the tongue to be deformed sideward and to further contact the other tongue for short circuit, such that the card connector can detect the insertion of the card.

For example, Taiwan Patent No. M267,600 disclosed a card connector having a plurality of tongues for detecting the insertion of various cards. As shown in FIGS. 1-3, the card connector includes a base frame 11, a plurality of terminals 12, a first conductive tongue 13, a second conductive terminal 14, and a slide member 15. The terminals 12 are mounted to a left rear end of the base frame 11. The first conductive tongue 13 is mounted to a right rear end of the base frame 11. The second conductive tongue 14 is mounted to a rear end of the base frame 11 and located between the terminals 12 and the first conductive tongue 13. The first and second conductive tongues 13 and 14 are spaced from each other for a predetermined interval. The slide member 15 is mounted to a right front end of the base frame 11. When inserted into the card connector, an electronic card 16 pushes and drives the slide member 15 to move toward the rear end of the base frame 11 for a distance and then the right front end of the card 16 pushes rightward against the second conductive tongue 14 to enable the second conductive tongue 14 to be elastically deformed to bend rightward for contact with the first conductive tongue 13, further enabling well stable electrical conduction between the first and second conductive tongues 13 and 14. When the card 16 is fully inserted into the card connector, the card 16 at a right edge thereof pushes and squeezes the second conductive tongue 14 to prevent the first and second conductive tongues 13 and 14 from electrical disconnection.

However, the detecting mechanism of the conventional card connector, i.e. the first and second conductive tongues 13 and 14, works in point-contact mode, such that it is subject to imperfect contact and unstable detection of signals.

### SUMMARY OF THE INVENTION

The primary objective of the present invention is to provide a card connector, which can stably detect signals of an inserted card and be conveniently operated.

The foregoing objective of the present invention is attained by the card connector composed of a base frame, a plurality of conductive terminals, a first conductive tongue, a second conductive tongue, and a slide member. The base frame includes a rear sidewall. The conductive terminals are inserted close to a first side of the rear sidewall. The first and second conductive tongues are inserted to the rear sidewall and located close to a second side of the terminals. The first conductive tongue includes a main body, a contact portion, a bended portion bending upward from one end of the main body, and a press portion extending toward one side of the second conductive tongue from a distal end of the bended portion. The second conductive tongue includes a main body. The press portion of the first conductive tongue is located above the main body of the second conductive tongue. When the press portion is moved downward to contact the main body of the second conductive tongue, the electrical conduction is enabled.

### BRIEF DESCRIPTION OF THE DRAWINGS

FIG. 1 is a perspective view of the conventional card connector, into which a card is initially inserted.

FIG. 2 is a top view of FIG. 1.

FIG. 3 is similar to FIG. 1, showing the card is fully inserted into the card connector.

FIG. 4 is a perspective view of the first preferred embodiment of the present invention which upper shell is separated therefrom.

FIG. 5 is another perspective view of the first preferred embodiment of the present invention, showing the conductive terminals, the first conductive tongue, the second conductive tongue, and the slide member.

FIG. 6 is a top view of the first preferred embodiment of the present invention which upper shell is removed therefrom.

FIG. 7 is similar to FIG. 6, showing the card is initially inserted into the card connector.

FIG. 8 is a sectional view taken along a line 8-8 indicated in FIG. 7.

FIG. 9 is similar to FIG. 6, showing the card is fully inserted into the card connector.

FIG. 10 is a sectional view taken along a line 10-10 indicated in FIG. 9.

FIG. 11 is a perspective view of a second preferred embodiment of the present invention which upper shell is separated therefrom.

FIG. 12 is another perspective view of the second preferred embodiment of the present invention, showing the conductive terminals, the first conductive tongue, the second conductive tongue, and an electronic card.

FIG. 13 is a top view of the second preferred embodiment of the present invention which upper shell is removed therefrom.

FIG. 14 is similar to FIG. 13, showing the card is fully inserted into the card connector.

FIG. 15 is a sectional view taken along a line 15-15 indicated in FIG. 14.

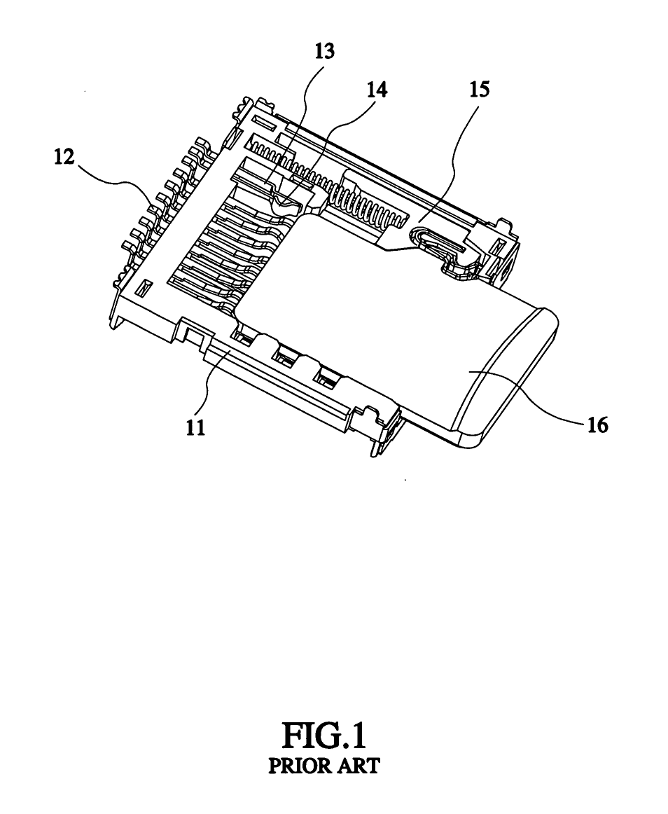

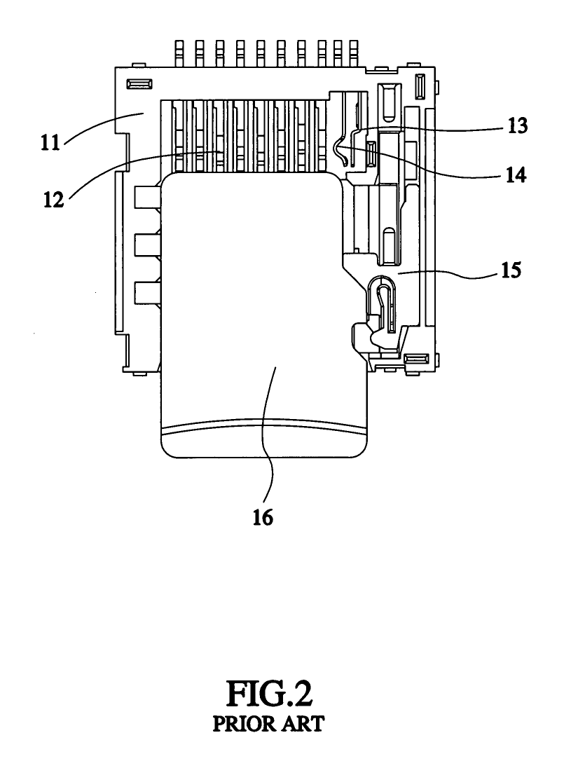

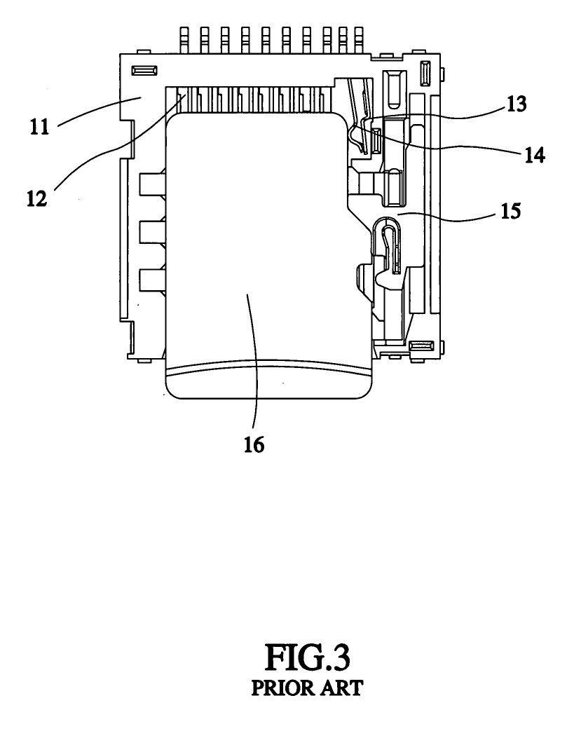

### DETAILED DESCRIPTION OF PREFERRED EMBODIMENTS

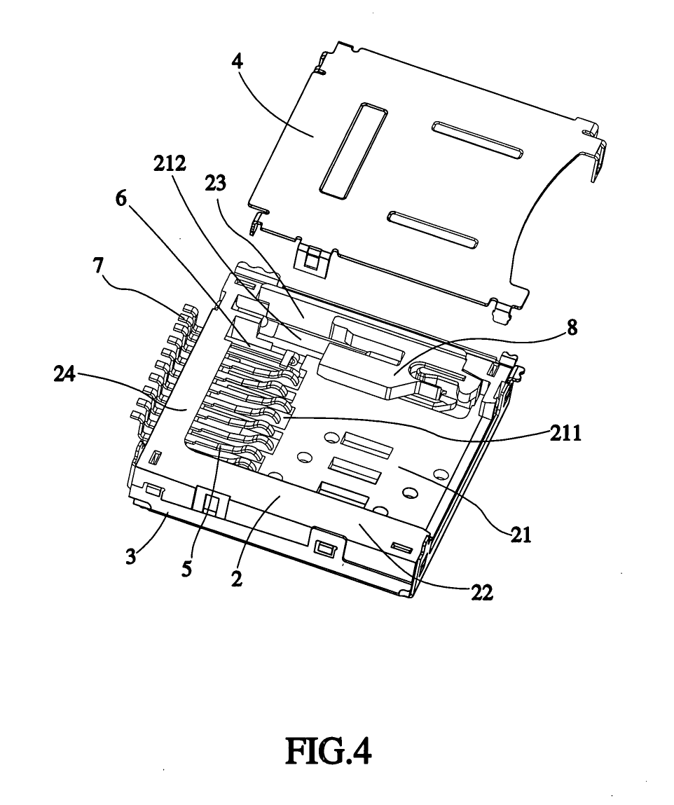

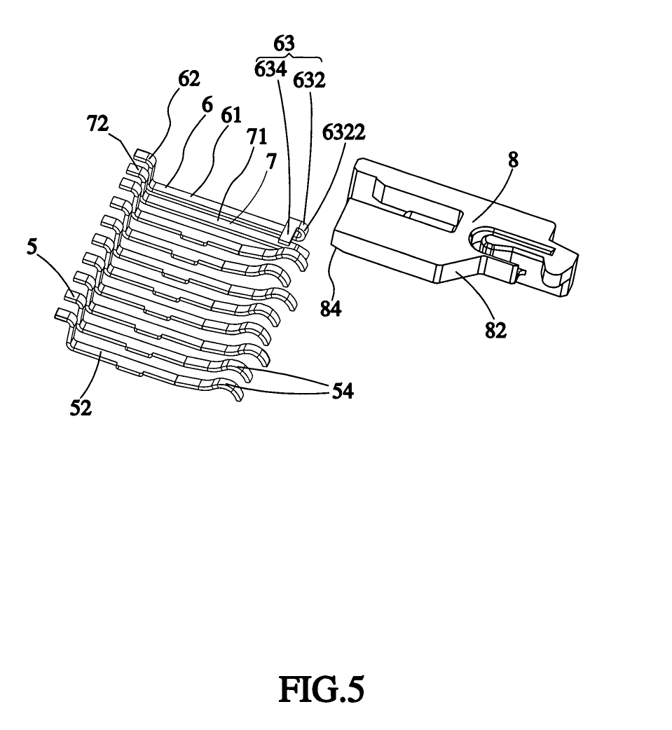

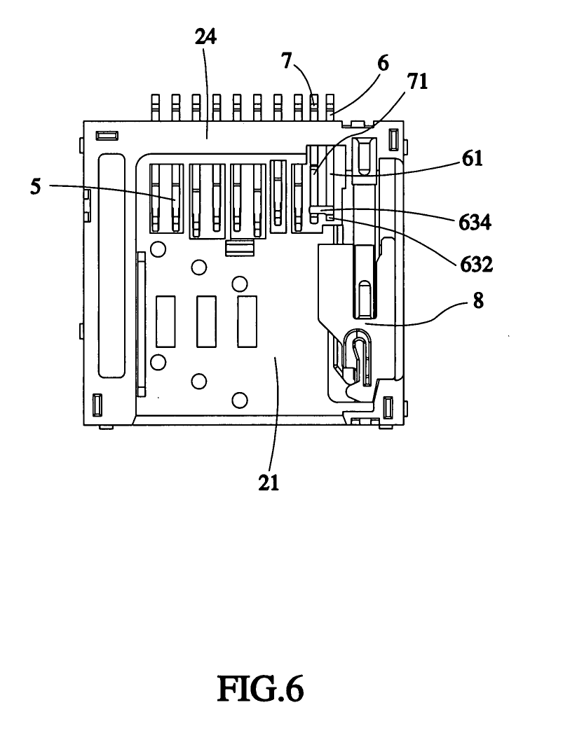

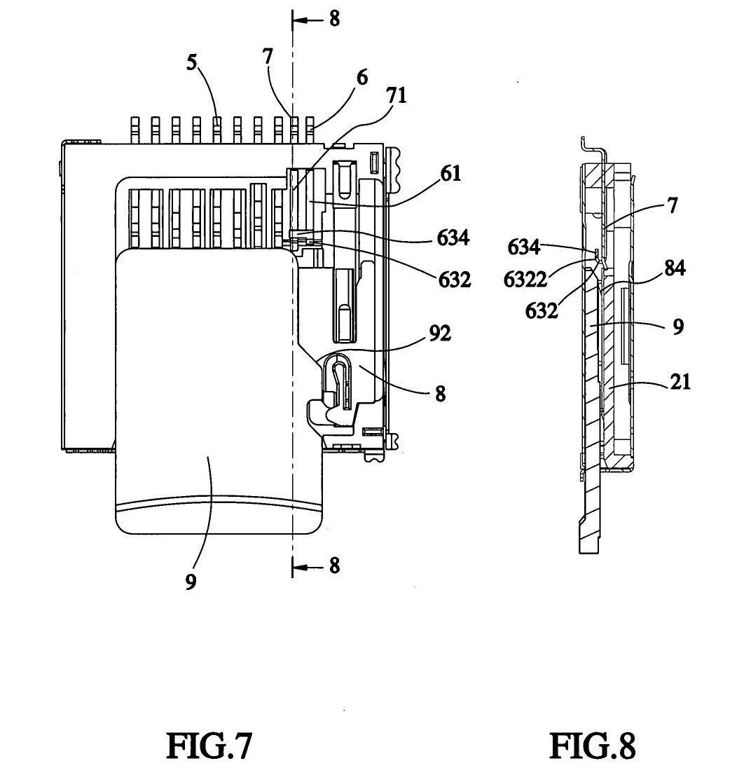

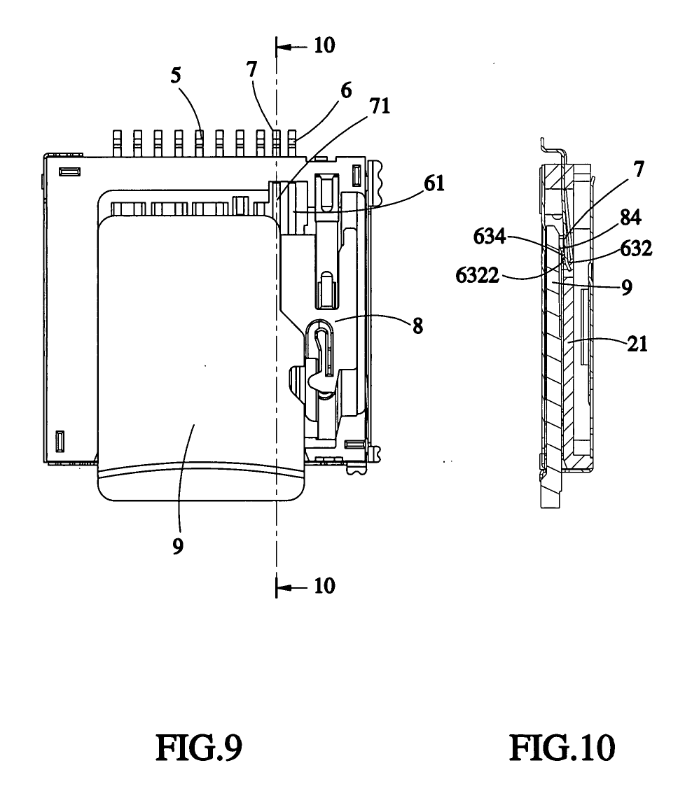

Referring to FIGS. 4-10, a card connector capable of detecting an inserted electronic card 9, constructed according to a first preferred embodiment of the present invention, is composed of a base frame 2, a lower shell 3, an upper shell 4, a plurality of conductive terminals 5, a first conductive tongue 6, a second conductive tongue 7, and a slide member 8. The electronic card 9 has an inclined pushing portion 92 formed at a midsection of the right side thereof

The base frame 2 includes a bottom sidewall 21, a left sidewall 22, a right sidewall 23, and a rear sidewall 24. The bottom sidewall 21 has a plurality of terminal slots 211 formed at a rear half part thereof and close to a left side thereof for receiving the terminals 5 respectively. The bottom sidewall has a slide way 212 formed close to a right side thereof. The left sidewall 22, the right sidewall 23, and the rear sidewall 24 are formed by extending upward from a left edge of, a right edge of, and a rear edge of the bottom sidewall 21 respectively. The lower shell 3 is made of a punched metallic material and buckled to a bottom side of the base frame 2. The upper shell 4 is made of a punched metallic material and buckled to a top side of the base frame 2.

The terminals 5 are inserted into the rear sidewall 24 of the base frame 2 and located close to a first (left) side thereof. Each of the terminals 5 has a root portion 52 inserted into the rear sidewall 24, and a contact portion 54 thereof received in the corresponding terminal slot 211.

Both of the first and second conductive tongues 6 and 7 are inserted into a second side of the rear sidewall 24. The first conductive tongue 6 is located close to the right side of the rear sidewall 24 and is made of an elastic metallic material. The first tongue 6 includes a main body 61, a solderable portion 62, and a contact portion 63. The main body 61 is an elongated bar. The solderable portion 62 is formed by bending vertically upward from one end of the main body 61 for a predetermined distance and is soldered onto an external circuit board (not shown). The contact portion 63 has a bended portion bending upward from the other end of the main body 61, a press portion thereof vertically extending from a distal end of the bended portion 632 toward one side of the second tongue 7 and located above the second tongue 7, and an inclined transitional portion 6322 formed close to a top side of the bended portion 632. The second tongue 7 is located close to the right side of the rear sidewall 24 and between the first tongue 6 and the terminals 5, made of an elastic metallic material. The second tongue 7 includes a main body 71 and a solderable portion 72. The main body 71 is an elongated bar. The solderable portion 72 is formed by bending vertically upward from one end of the main body 71 for a predetermined distance and is soldered onto an external circuit board (not shown). The press portion 634 is located above the main body 71 of the second tongue 7. When the press portion 634 presses the contact portion 63 downward, the press portion 634 is moved downward to contact the main body 71 for electrical conduction and then short circuit, thus attaining detection of the insertion of the card 9.

The slide member 8 is slidably mounted in the slide way 212 to be slidable back and forth along a direction that the card is inserted into the card connector. The slide member 8 has a pushed portion 82 formed at a left end thereof and corresponding to the pushing portion 92 of the card 9, and a lower bevel 84 formed at a left bottom side thereof and corresponding to the transitional portion 6322.

The card connector further includes an ejecting mechanism composed of a spring (not shown), a guide bar (not shown), and a heart-shaped groove formed on the slide member 8 for ejecting the card. Since the ejecting mechanism belongs to the prior art and is not the significant feature of the present invention, no more description is necessary.

After the card connector is assembled, when the card 9 is inserted into the card connector, the pushing portion 92 contacts against the pushed portion 82 of the slide member 8 to drive the slide member 8 to move backward and then the bottom side of the slide member 8 contacts against the contact portion 63 of the first conductive tongue 6 to enable the contact portion 63 and the main body 61 to deformably bend downward. The lower bevel 84 and the transitional portion 6322 work with each other to facilitate the insertion of the card 9. When the card 9 is fully inserted, the press portion 634 of the first tongue 6 contacts the main body 71 of the second tongue 7 for electrical conduction and short circuit, thus enabling detection of the inserted card.

When the card 9 is ejected, the slide member 8 is moved back to a front end of the slide way 212 and the first tongue 6 is no longer squeezed by the slide member 8 to rebound, the contact portion 63 bounces back to where is originally located above the main body 71, and then the press portion 634 and the main body 71 are no longer in contact with each other. Accordingly, the card connector is no longer short-circuit and ready for another detection while the card 9 is inserted next time.

In this embodiment, the structure of the present invention can avoid direct contact between the card 9 and the first conductive tongue 6, and meanwhile, the bended portion 632 and the press portion 634 structurally guaranteeing the stable detection of signals. After the card 9 is ejected, the slide member 8 returns and the first tongue 6 is no longer squeezed to rebound to where is located above the main body 71 for detection of next insertion of the card 9.

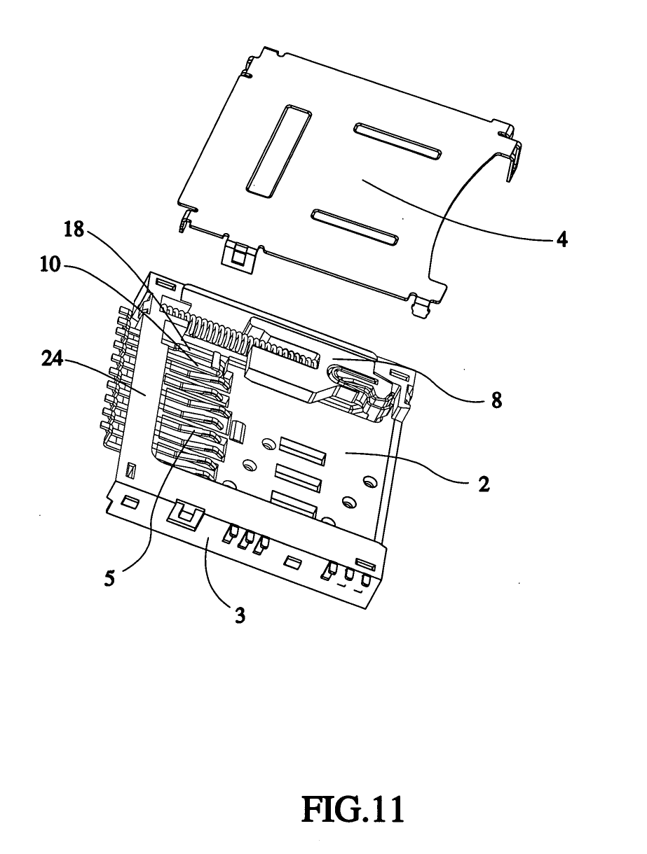

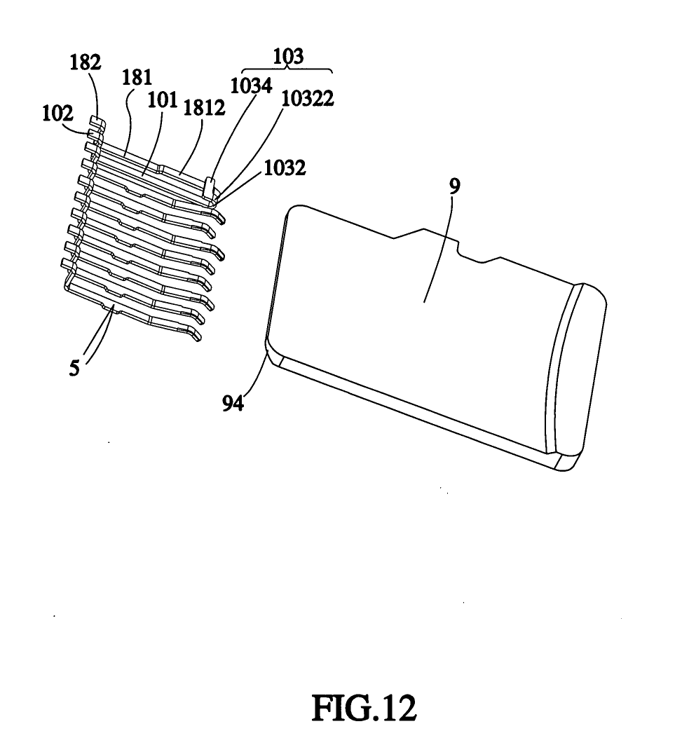

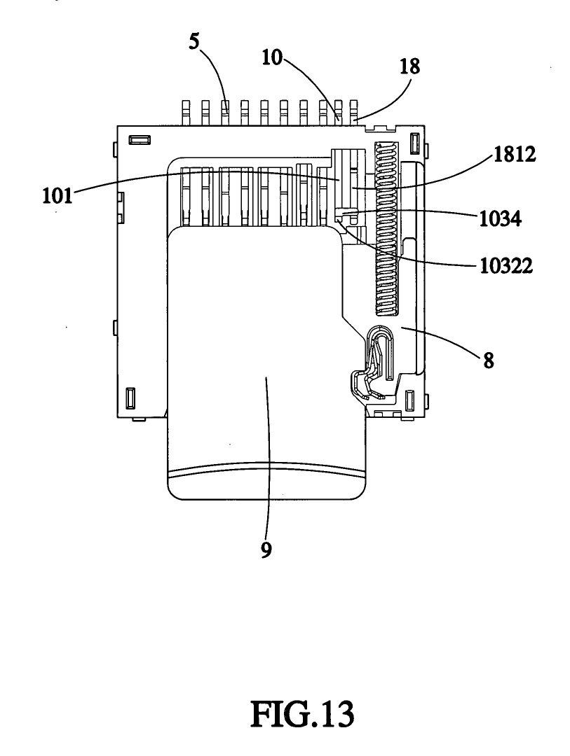

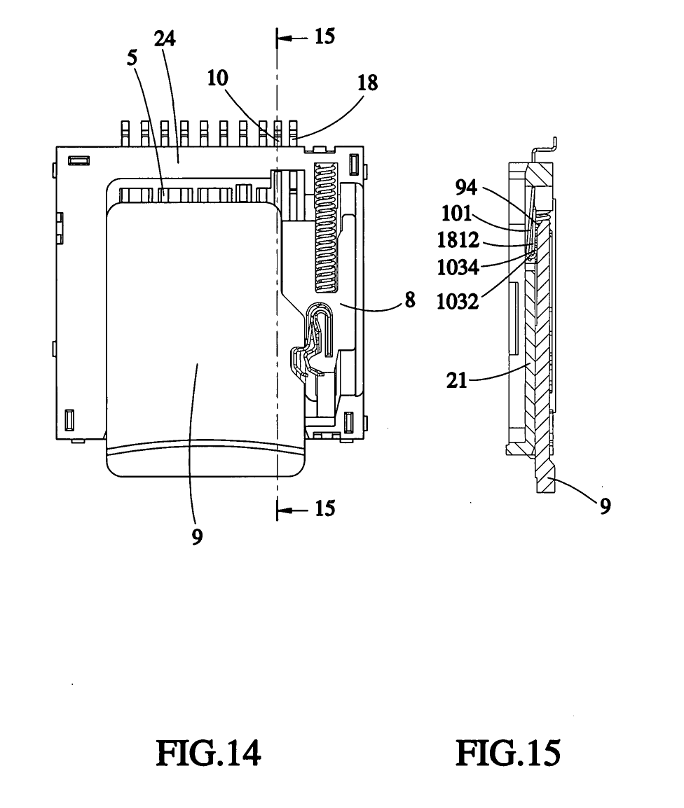

Referring to FIGS. 11-15, a card connector capable of detecting an inserted electronic card 9 constructed according to a second preferred embodiment of the present invention is similar to the first embodiment but different as recited below.

The first conductive tongue 10 and the second conductive tongue 18 are inserted onto the rear sidewall 24 and beside the terminals 5. Both of the first and second tongues 10 and 18 are located close to the right side of the rear sidewall 24. The first tongue 10 is located between the second tongue 18 and the terminals 5. The first tongue 10 includes a main body 101, a solderable portion 102, and a contact portion 103. The contact portion 103 has a bended portion 1032 bending upward from the main body 101, a press portion 1034 vertically extending from a distal end of the bended portion 1032 toward one side the second tongue 18, and an inclined transitional portion 10322 formed close to a top end thereof. The press portion 1034 is located above the second tongue 18. The main body 181 further has a contact potion 1812 formed at a front side thereof and bending upward for a predetermined distance and extending forward. The second contact portion 1812 is located higher than that of the first embodiment, such that it more easily contacts the press portion 1034 for electrical conduction.

In the second embodiment, after the card 9 is inserted into the card connector, the bottom side of the card 9 contacts against the contact portion 103 of the first conductive tongue 10, and the inclined portion 94 of the card 9 works with the transitional portion 10322 of the bended portion 1032 of the first conductive tongue 10 to enable more laborsaving and smooth insertion of the card 9. When the card 9 is fully inserted, the press portion 1034 of the first tongue 10 contacts the contact portion 1812 of the second tongue 18 to enable the electrical conduction and then the short circuit to result in detection of the insertion of the card 9. After the card 9 is ejected from the card connector, the first tongue 10 is no longer squeezed by the second tongue 18 to rebound and this the contact potion 103 rebounds to where is originally located above the contact portion 1812 of the main body 181 of the second tongue 18; meanwhile, the press portion 1034 and the main body 181 no longer contact each other and thus the card connector is no longer short-circuit and is ready for detection of next insertion of the card 9.

In the first embodiment, the conductive terminals 5 are mounted close to the left side of the base frame 2, and the first and second conductive tongues 6 and 7 and the slide member 8 are mounted close to the right side of the base frame 2. In light of this, the terminals 5 can be alternatively mounted close to the right side of the base frame 2, and the first and second conductive tongues 6 and 7 and the slide member 8 can be alternatively mounted close to the left side of the base frame 2, likewise attaining the primary objective of the present invention as the same as the first embodiment does.

In the second embodiment, the conductive terminals 5 are mounted close to the left side of the base frame 2, and the first and second conductive tongues 10 and 18 and the slide member 8 are mounted close to the right side of the base frame 2. In light of this, the terminals 5 can be alternatively mounted close to the right side of the base frame 2, and the first and second conductive tongues 10 and 18 and the slide member 8 can be alternatively mounted close to the left side of the base frame 2, likewise attaining the primary objective of the present invention as the same as the second embodiment does.

Although the present invention has been described with respect to the specific preferred embodiments thereof, it is no way limited to the details of the illustrated structures but changes and modifications may be made within the scope of the appended claims.

1. A card connector capable of detecting an inserted card, comprising:
a base frame having a rear sidewall;
a plurality of conductive terminals located close to a first side of said rear sidewall;
a first conductive tongue having a main body and a contact potion, said contact portion having a bended portion and a press portion, said bended portion bending upward from an end of said main body; and
a second conductive tongue having a main body;
wherein said contact portion further includes a press portion extending from a distal end of said bended portion toward either left or right side of said second tongue, said first and second tongues are located close to a second side of said rear sidewall, and said press portion of said first tongue can be moved downward to contact said main body of said second tongue to enable electrical conduction.

2. The card connector as defined in claim 1, wherein said first side is the left side and said second side is the right side.

3. The card connector as defined in claim 1, wherein said first side is the right side and said second side is the left side.

4. The card connector as defined in claim 2 or 3, wherein said first conductive tongue is located close to the second side of said rear sidewall, and said second conductive tongue is located on said rear sidewall and between said first conductive tongue and said terminals.

5. The card connector as defined in claim 4 further comprises a slide member slidably mounted on said base frame, said slide member having a bottom side lying on said contact portion of said first conductive tongue to drive said press portion to move downward and to contact said main body of said second conductive tongue for electrical conduction.

6. The card connector as defined in claim 5, wherein said bended portion has an inclined transitional portion formed close to a top end thereof; said slide member has an inclined lower bevel formed at the bottom side thereof and corresponding to said transitional portion.

7. The card connector as defined in claim 2 or 3, wherein said second conductive tongue is located close to the second side of said rear sidewall; said first conductive tongue is located on said rear sidewall and between said second tongue and said terminals.

8. The card connector as defined in claim 7, wherein said bended portion has an inclined transitional portion corresponding to an inclined portion formed at a front bottom side of said card inserted into said card connector.
